(19) United States
(12) Patent Application Publication
(10) Pub. No.: US 2025/0077846 A1
(43) Pub. Date: Mar. 6, 2025

(54) SYSTEMS AND METHODS FOR IN-PLACE CIRCULAR BUFFERING IN CONVOLUTIONAL NEURAL NETWORKS AND FOR EMPLOYING INSTRUCTION-BASED CONVOLUTIONAL NEURAL NETWORKS

(71) Applicant: META PLATFORMS, INC., Menlo Park, CA (US)

(72) Inventors: Xianliang Zha, El Dorado Hills, CA (US); Yunqing Chen, Los Altos, CA (US); Harikrishna Madadi Reddy, San Jose, CA (US); Lei Feng, Sunnyvale, CA (US); Chien Cheng Liu, San Jose, CA (US); Raghuvardhan Moola, Fremont, CA (US)

(21) Appl. No.: 18/461,079

(22) Filed: Sep. 5, 2023

(51) Int. Cl. G06N 3/0464

(52) U.S. Cl. CPC G06N 3/0464

(57) ABSTRACT

The present application at least describes a method including a step of receiving, at a convolutional neural network (CNN), data over a network from a source. The CNN may include one or more blocks. Each block may include plural layers. The method may include a step of causing, via the CNN in a first layer of the first block, a representation of the received data as a first matrix having M rows and N columns. The M rows and N columns may be greater than or equal to 1. The method may also include a step of processing, via the CNN at the first layer of the first block, the first matrix via a predetermined kernel matrix. The kernel matrix may include M-X rows and N-Y columns. X and Y may be greater than or equal to 1. The method may also include a step of rendering, via the CNN based on the processed first matrix, a second matrix having M-2 rows and N-2 columns. The method may further include a step of causing, via the CNN in a second layer of the first block, a representation including a first buffer and the second matrix. The first buffer may include at least 2 columns of the first matrix. The method may include yet a further step of processing, via the CNN at the second layer of the first block, the second matrix via the predetermined kernel matrix. The method may include yet even a further step of rendering, via the CNN based on the processed second matrix, a third matrix having M-4 rows and N-4 columns.

### TECHNICAL FIELD

The present application generally is directed to systems and methods for in place circular buffering in convolutional neural networks (CNNs).

### BACKGROUND

CNNs are being used to solve a vast array of challenging machine learning problems. These may include, for example, natural language processing, computer vision and recommendation systems. CNNs comprise a series of computation layers, where each layer takes the output of the preceding layer as its input. In so doing, CNNs may achieve extraordinary results with regard to image object recognition accuracy, object detection and classification. However, the trade-off for these results is high computational cost.

In conventional architectures, image and/or video data stored on an external memory are transmitted to and read by a CNN coupled to a processor either on a server or consumer product. The received image and/or video data is fed to a first layer of a block of a CNN. An output of the first layer is written back to the external memory. Back and forth reading-writing between the external memory and the CNN coupled to the processor continues until every layer in a block of the CNN has been processed. The processing power and signal bandwidth costs associated with conventional architectures may be extraordinarily high. Additionally, conventional architectures employing these techniques may take significantly longer to complete the processing of a single block of a CNN having many layers.

What is desired in the art is a more efficient and cost-effective architecture to handle communications between an external memory and a system on a server or consumer product.

What is also desired in the art is a system that optimizes limited power resources shared by plural concurrently running applications accessing the external memory to improve throughput and ease congestion.

### A. Systems And Methods For In-place Circular Buffering In Convolutional Neural Networks

### BRIEF SUMMARY

One aspect of the application at least describes a method including a step of receiving, at a convolutional neural network (CNN), data over a network from a source. The CNN may include one or more blocks. Each block may include plural layers The method may include a step of causing, via the CNN in a first layer of the first block, a representation of the received data as a first matrix having M rows and N columns. The M rows and N columns may be greater than or equal to 1. The method may also include a step of processing, via the CNN at the first layer of the first block, the first matrix via a predetermined kernel matrix. The kernel matrix may include M-X rows and N-Y columns. X and Y may be greater than or equal to 1. The method may also include a step of rendering, via the CNN based on the processed first matrix, a second matrix having M-2 rows and N-2 columns. The method may further include a step of causing, via the CNN in a second layer of the first block, a representation including a first buffer and the second matrix. The first buffer may include at least 2 columns of the first matrix. The method may include yet a further step of processing, via the CNN at the second layer of the first block, the second matrix via the predetermined kernel matrix. The method may include yet even a further step of rendering, via the CNN based on the processed second matrix, a third matrix having M-4 rows and N-4 columns.

It will also be understood that the methods and apparatuses described in the present application allow for an instruction-based solution that decouples the complexity and intensive calculations of conventional CNN hardware circuit designs. For example, one or more of the data buffers may be employed as a general-purpose register. The data buffer may provide firmware with full access to these general registers. An exemplary architecture according to the instant application describes an instruction-based approach such that firmware may require a small compiler to pre-generate instructions per application. In so doing, the instruction-based approach improves computer functionality by reducing hardware validation efforts based on solutions performed by firmware. In addition, the instruction-based approach may be seen as an improvement in the field of networking technology by preventing or reducing circuit data tracking issues.

Another aspect of the application at least describes an apparatus including a non-transitory memory including stored instructions. The apparatus also includes a processor operably coupled to the non-transitory memory that is configured to execute the stored instructions. One of the instructions may include receiving, at a convolutional neural network (CNN), data over a network from a source. The CNN may include one or more blocks. Each block may include plural layers Another one of the instructions may include a step of causing, via the CNN in a first layer of the first block, a representation of the received data as a first matrix having M rows and N columns. The M rows and N columns may be greater than or equal to 1. Another instruction may also include a step of processing, via the CNN at the first layer of the first block, the first matrix via a predetermined kernel matrix. The kernel matrix may include M-X rows and N-Y columns. X and Y may be greater than or equal to 1. Yet another instruction may include rendering, via the CNN based on the processed first matrix, a second matrix having M-2 rows and N-2 columns. A further instruction may include causing, via the CNN in a second layer of the first block, a representation including a first buffer and the second matrix. The first buffer may include at least 2 columns of the first matrix. An even further instruction may include processing, via the CNN at the second layer of the first block, the second matrix via the predetermined kernel matrix. A further instruction may include rendering, via the CNN based on the processed second matrix, a third matrix having M-4 rows and N-4 columns.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The summary, as well as the following detailed description, is further understood when read in conjunction with the appended drawings. For the purpose of illustrating the disclosed subject matter, the drawings depict examples and aspects of the disclosed subject matter. However, the disclosed subject matter is not limited to the specific methods and devices disclosed. In addition, the drawings are not necessarily drawn to scale. In the drawings:

FIG. 1A illustrates a communication system in accordance with the present application.

FIG. 1B illustrates a machine learning architecture in accordance with the present application.

FIG. 2 illustrates an example node in accordance with the present application.

FIG. 3 illustrates a block diagram of an example computing system in accordance with the present application.

FIG. 4 illustrate an example flowchart in accordance with the present application.

FIG. 5 illustrates an example in accordance with the present application.

FIG. 6 illustrates an example pre-processing module in accordance with the present application.

FIG. 7 illustrates in an example CNN core in accordance with the present application.

FIG. 8 illustrates in an example post-processing module accordance with the present application.

FIG. 9 illustrates an example control module in accordance with the present application.

FIG. 10 illustrate an example flowchart in accordance with the present application.

FIG. 11 illustrates an example in accordance with the present application.

FIG. 12A, FIG. 12B, FIG. 12C, FIG. 12D, FIG. 12E and FIG. 12F illustrate examples in accordance with the present application.

FIG. 13 illustrates an example instruction format of the present application.

FIG. 14A and FIG. 14B illustrate an example instruction for layer 1 and layer 2 of a block in accordance with the present application.

FIG. 15A, FIG. 15B and FIG. 15C illustrate an example with plural buffers in a layer of the block in accordance with the present application.

FIG. 16 illustrates an example flowchart in accordance with the present application.

The figures depict various examples for purposes of illustration only. One skilled in the art will readily recognize from the following discussion that alternative examples of the architectures and methods illustrated herein may be employed without departing from the principles described herein.

### DETAILED DESCRIPTION

Some examples of the present disclosure will now be described more fully hereinafter with reference to the accompanying drawings, in which some, but not all examples of the disclosure are shown. Indeed, various examples of the disclosure may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the present application. It is to be understood that the methods and systems described herein are not limited to specific methods, specific components, or to particular implementations.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

It will be understood the methods and apparatuses described in the present application may allow for an elegant solution to minimize processing power and reduce costs associated with multiple back and forth communication between an external memory and a CNN and processor. By employing a circular buffer at each layer of a block in the CNN, image and/or video data may be read once from the external memory and written back after all layers in the block have been processed.

It will also be understood the methods and apparatuses described in the present application allow for an instruction-based solution that decouples the complexity and intensive calculations of conventional CNN hardware circuit designs. For example, one or more of the data buffers may be employed as a general-purpose register. The data buffer may provide firmware with full access to these general registers. An exemplary architecture according to the instant application describes an instruction-based approach such that firmware may require a small compiler to pre-generate instructions per application. In so doing, the instruction-based approach improves computer functionality by reducing hardware validation efforts based on solutions performed by firmware. In addition, the instruction-based approach may be seen as an improvement in the field of networking technology by preventing or reducing circuit data tracking issues.

### General Architecture

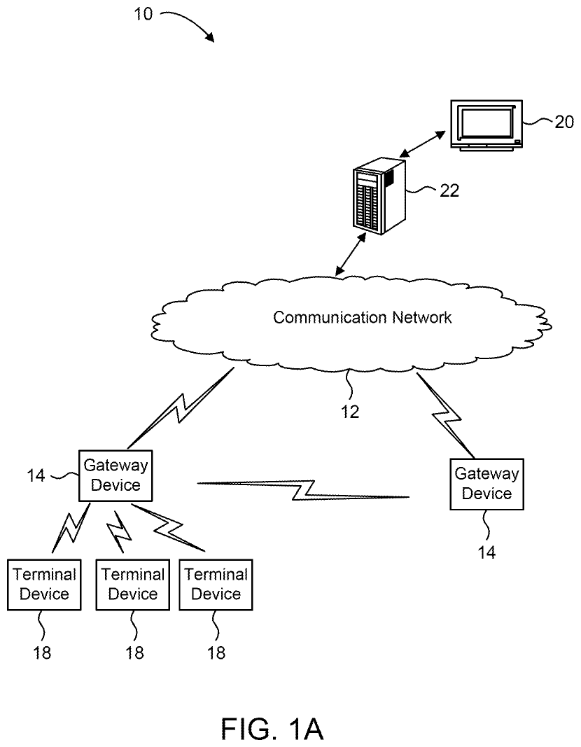

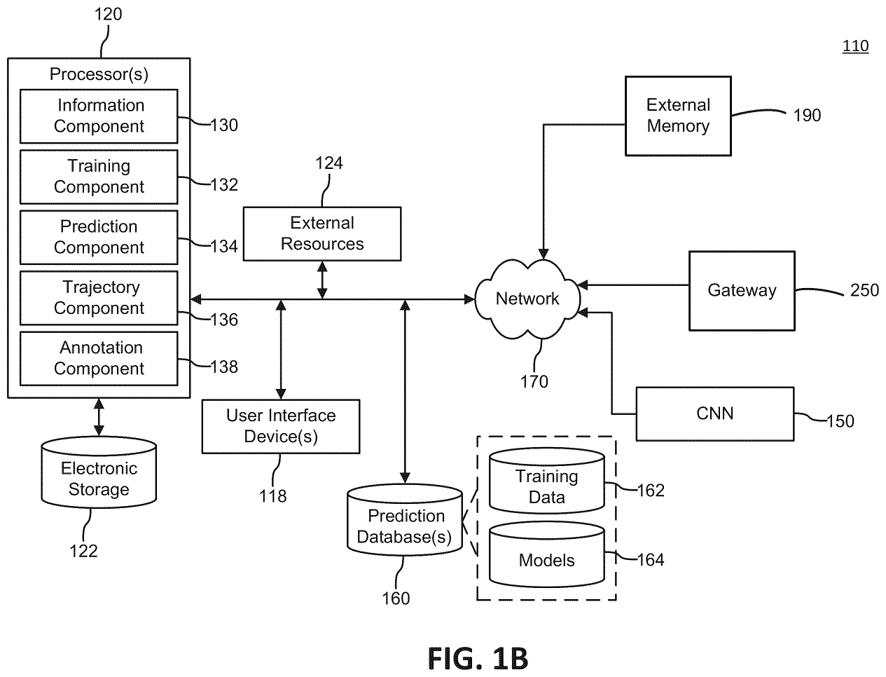

FIG. 1A is a diagram of an example communication system 10 in which one or more disclosed examples may be implemented. As shown in FIG. 1A, the communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. For example, the communication network 12 may comprise other networks such as a core network, the Internet, a sensor network, an industrial control network, a personal area network, a fused personal network, a satellite network, a home network, or an enterprise network for example.

It will be appreciated that any number of gateway devices 14 and terminal devices 18 may be included in the communication system 10 as desired. Each of the gateway devices 14 and terminal devices 18 are configured to transmit and receive signals via the communication network 12 or direct radio link. The gateway device 14 allows wireless devices, e.g., cellular and non-cellular as well as fixed network devices, e.g., PLC, to communicate either through operator networks, such as the communication network 12 or direct radio link. For example, the devices 18 may collect data and send the data, via the communication network 12 or direct radio link, to an application 20 or devices 18. Further, data and signals may be sent to and received from the application 20 via a service Layer 22, as described below. In one example, the service Layer 22 may be a PCE. Devices 18 and gateways 14 may communicate via various networks including, cellular, WLAN, WPAN, e.g., Zigbee, 6LoWPAN, Bluetooth, direct radio link, and wireline for example.

FIG. 1A is a diagram of an example communication system 10 in which one or more disclosed examples may be implemented. As shown in FIG. 1A, the communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. For example, the communication network 12 may comprise other networks such as a core network, the Internet, a sensor network, an industrial control network, a personal area network, a fused personal network, a satellite network, a home network, or an enterprise network for example.

It will be appreciated that any number of gateway devices 14 and terminal devices 18 may be included in the communication system 10 as desired. Each of the gateway devices 14 and terminal devices 18 are configured to transmit and receive signals via the communication network 12 or direct radio link. The gateway device 14 allows wireless devices, e.g., cellular and non-cellular as well as fixed network devices, e.g., PLC, to communicate either through operator networks, such as the communication network 12 or direct radio link. For example, the devices 18 may collect data and send the data, via the communication network 12 or direct radio link, to an application 20 or devices 18. Further, data and signals may be sent to and received from the application 20 via a service Layer 22, as described below. In one example, the service Layer 22 may be a PCE. Devices 18 and gateways 14 may communicate via various networks including, cellular, WLAN, WPAN, e.g., Zigbee, 6LoWPAN, Bluetooth, direct radio link, and wireline for example.

According to an aspect of the present application, the architecture may include machine learning architecture, as illustrated in FIG. 1B. In one example, the architecture may reside at a server. Alternatively, the architecture may reside on a consumer product or device, such as a computer system. More specifically, the architecture may include a processor operably coupled to one or more databases that may include the CNN. In an example, the processor may be reference indicator 120 in FIG. 1B. The CNN may be reference indicator 150 as depicted in FIG. 1B. The CNN may include one or more blocks. Each of the one or more blocks may include, for example, at least one of: an information component 130, a training component 132, a prediction component 134, a trajectory component 136, or an annotation component 138. The processors may be in communication with electronic storage 122, external resources 124, user interface device(s) 118, prediction database(s) 160, which may include training data 162 and/or models 164. The processors 120 may also be in network communication with one or more external memories 190, gateway devices 250, or CNNs 150.

According to an example, data may be located in an external memory, such as for example, a DDR memory. The data may include any one or more of image data or video data. In an example, the data may include pixels. In an example, the external memory may be depicted as reference indicator 190 in FIG. 1B. External memory 190 may communicate with the system including the processor 120 and CNN 150 via network 170.

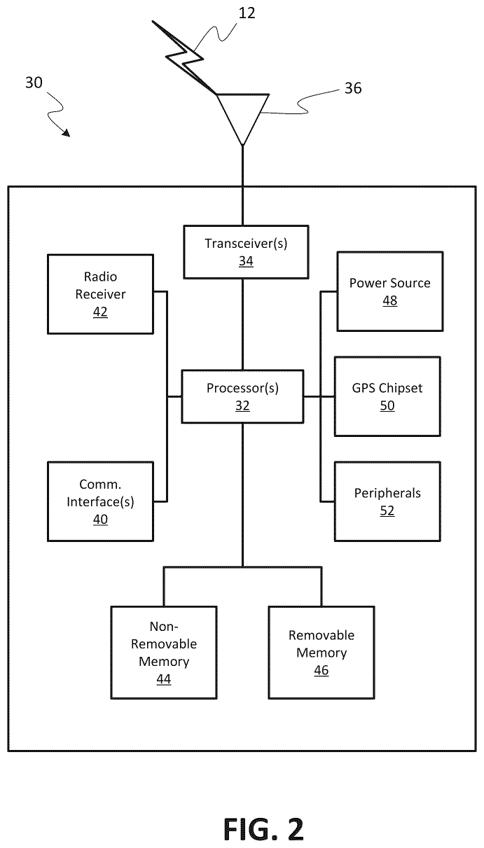

FIG. 2 illustrates a block diagram of an exemplary hardware/software architecture of user equipment (UE) 30. The architecture may be used in conjunction with the system (e.g., communication system 10) depicted in FIG. 1A. As shown in FIG. 2, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-Layer programs (e.g., browsers) and/or radio access-Layer (RAN) programs and/or other communications programs. The processor 32 may also perform security operations such as authentication, security key agreement, and/or cryptographic operations, such as at the access-Layer and/or application Layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

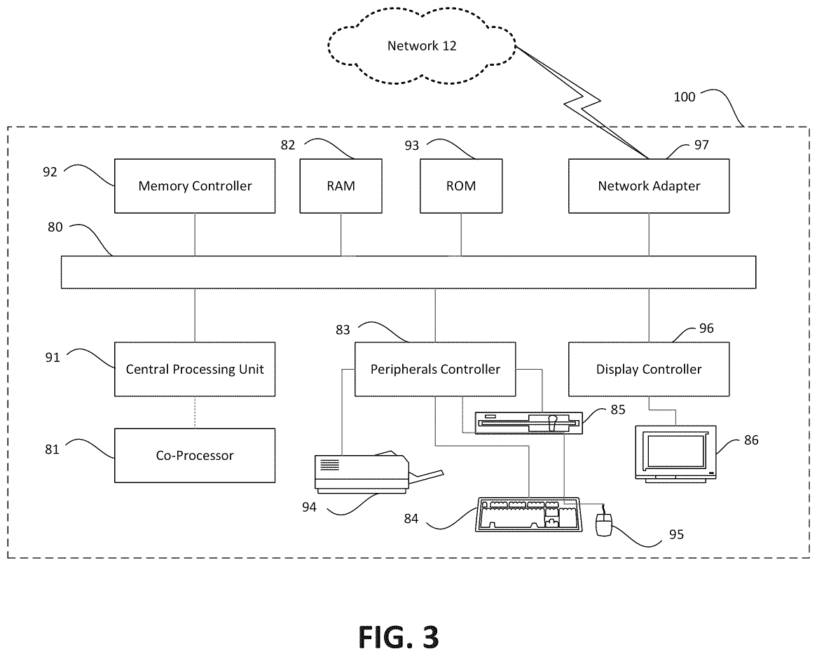

FIG. 3 is a block diagram of an exemplary computing system 100 which may also be used to implement components of the system or be part of the UE 30. The computing system 100 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 100 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 100 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 100 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 100. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 100 may contain communication circuitry, such as for example a network adaptor 97, that may be used to connect computing system 100 to an external communications network, such as network 12, to enable the computing system 100 to communicate with other nodes (e.g., UE 30) of the network.

### Block Based CNN Architecture

A convolutional neural network (CNN) may comprise an input and an output layer, as well as multiple hidden layers. The hidden layers of a CNN typically comprise a series of convolutional layers that convolve with a multiplication or other dot product. The activation function is commonly a ReLU layer and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

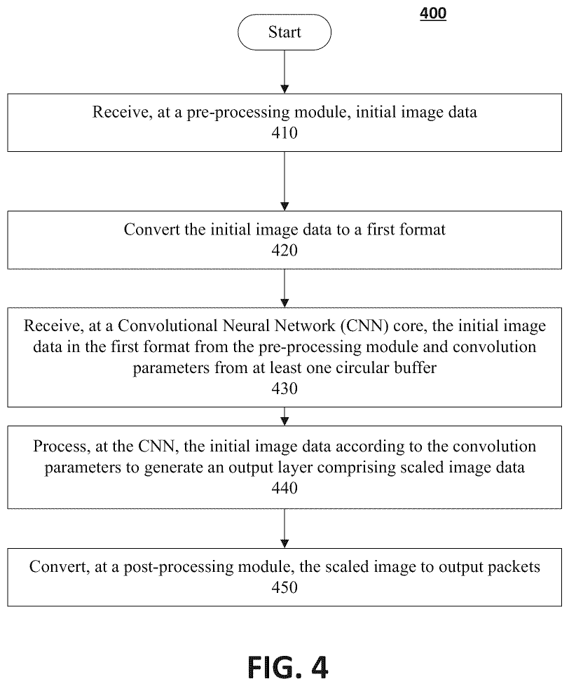

FIG. 4 illustrates a flowchart of an example process 400 according to an aspect of this application. In some implementations, one or more process blocks of FIG. 4 may be performed by a device. The example process 400 may be an image operation, including but not limited to a scaling operation (e.g., up-scaling, down-scaling), a resizing operation, a noise reduction operation, or a resolution improvement operation, among other operations.

As shown in FIG. 4, block 410 may include receiving, at a pre-processing module, initial image data. Such initial image data may be raw image data, pre-processed image data, data in a first color space, and the like. For example, initial image data may be in a color space including but limited to RGB, YUV, HSL, or CMYK.

At block 420, the pre-processing module may convert the initial image data to a first format. The first format may be a particular color space, such as converting the image data to RGB. In some examples, the initial image data may go through color space conversion and/or chroma up-sampling. For example, Chromo420 data may go through up-sampling to Chroma44, or Chroma444 data may go through color space conversion, e.g., to RGB444. Blocks 410 and 420 may be optional, and various aspects include one or both operations.

At block 430, a convolutional neural network core module may receive the initial image data in the first format from the pre-processing module or the previous layer result from one of the circular buffers, and convolution parameters from the kernel buffer which has the pre-loaded parameters for each CNN layer process. The CNN core may include one or more in-place internal circular buffer. These may include, but are not limited to, and aux circular buffer, a main circular buffer, a kernel buffer, and a buffer for ReLU parameters. In some examples, the internal circular buffers may feed data into convolution circuit and layer adder to manage optimization operations. The buffers may include temporary buffers and/or serve as a location where a layer output may be saved.

A multiplexer, i.e., mux unit, may receive the initial image data, previous layer result, and parameters from one or more buffers. In some examples, the multiplexer may be managed, at least in part, by the control module. Such data may then be fed into the convolution circuit to process the input image data (the initial image or the previous layer result) and determine the next layer.

At block 440, the CNN may process the input image data according to the convolution parameters to generate an output layer comprising processed image data. The convolution parameters may include kernel parameters associated with a scaling operation and may be determined based on at least one machine learning module, which may be external or internal the CNN core module. The result image can be fed back into the circular buffer or transmitted into the post-process unit.

At block 450, at a post-processing module, the scaled image may be converted to output packets. The output packets may optionally be provided to an external device, such as an external memory. In various examples, the output packet format may be customized, e.g., depending on where they are to be delivered.

Accordingly, the discussed systems and methods may provide video and image scaling, frame rate conversions, noise reductions, and other image operations. For example, a video may be converted from 30 frames per second (fps) to 60 fps. In another example, a video may be converted from 120 fps down to 60 fps.

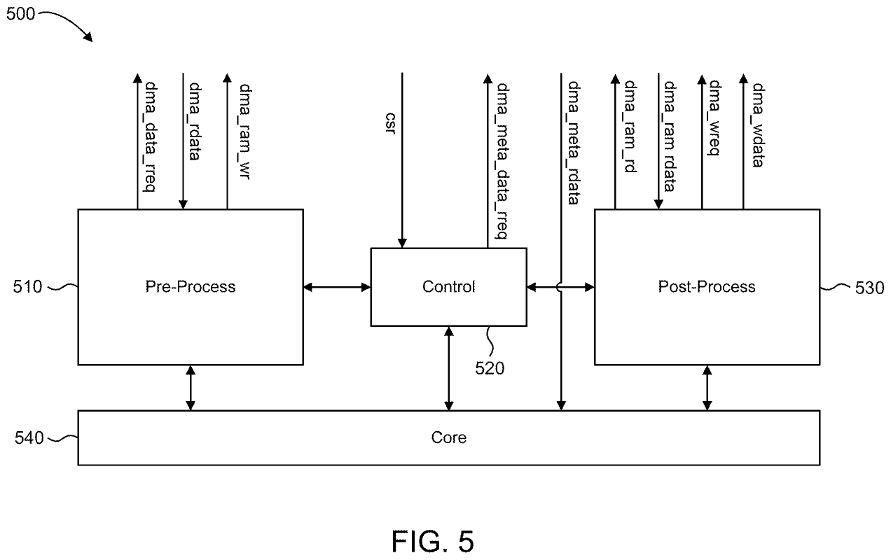

To further explain the concepts described above, the example depicted in FIG. 5 shows a block-based CNN system architecture. The CNN system may include a Pre-Processing block 510, a CNN Core 540, a Post-Processing block 530, and a Control block 520. The CNN system architecture 500 and its blocked design significantly reduces system bandwidth and power compared to traditional convolutional neural network arrangements.

In various examples, at least one in-place circular buffer may be included and configured to make left-neighbor data and input data into a continuous data space. Instruction-based operations enable the internal in-place circular buffer to function similarly to general purpose registers of a CPU and give firmware or drivers full control of the buffer.

As further discussed herein, the Pre-Process module 510 and Post-Process module 530 may enable up-sampling of images, from end-to-end, to obtain a high quality vision effect. In addition, kernels, such as a super-resolution kernel re-configuration reduces Depth-to-Space conversions with power and performance improvements.

The Pre-Process block 510 may handle input channel data reads, chroma up-sampling, color space conversion, and first layer data buffer management.

The Core block 540 primarily processes layer convolutions, ReLU, layer copies, layer adds, intermediate layer data buffer management, and meta data management. Metadata may include, but is not limited to kernel and ReLU data.

The Control block 520 may communicate with each of the other blocks-Pre-Process 510, Core 540, and Post-Process 530—with the pre-generated different control signals for the different pipeline stages to orchestrate communications between and operations of the other systems for seamless operation and integration.

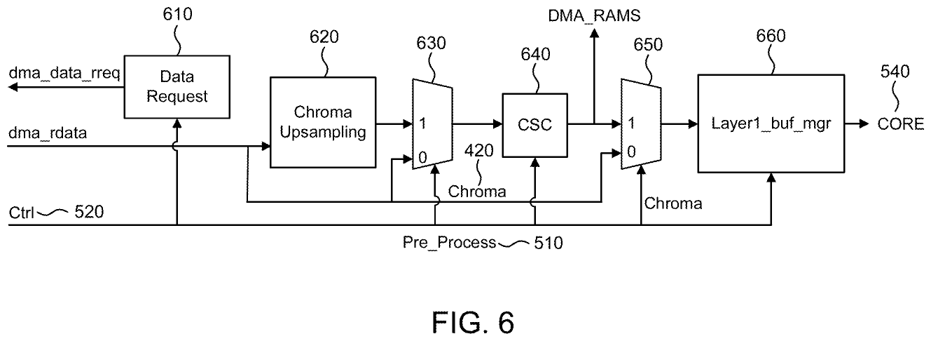

FIG. 6 provides an example architecture of the pre-process block. According to various aspects data request 610 may receive block level parameters from the control block 520, and generate a request to a memory, e.g., Direct Memory Access (DMA). Read data returned from the memory (e.g., referred to herein as DMA) may feed into one of three modules: Chroma Up-sampling 620, Color Space Conversion 640, or layer1_buf_mgr 660-based on the input data formats.

In a first example, read data including Chroma420 data may go to the Chroma Up-Sampling module 620. The Up-Sampling module 620 may convert chroma420 data to chroma444. From there, a verification 630 may determine whether data may be passed to the CSC. In another example, up-sampled chroma 444 data may pass through verification 630 and to the CSC 640. Chroma420 data may be prevented from being passed to the CSC 640.

In yet another example, read data including Chroma444 data may go to the Color Space Conversion (CSC) module 640. The CSC may convert Chroma444 to RGB444 into the DMA-shared buffer. In some examples, this may occur if output needs to add back source RGB data. As mentioned above, the CSC 640 may receive data up-sampled from the up-sampling module 620 or directly from the input, and further convert the up-sampled data, e.g., to RGB. In some examples, input/output CSC format conversion may be supported when the input is in RGB or Y formats. The CSC 640 may also support down-scaling or even no-scaling. According to some aspects, a no source add back may be supported, especially when the ADD input from MUX is zero.

In a third example, read data including RGB data may go to a buffer manager, e.g., layer1_buf_mgr 660. Layer1_buf_mgr 660 may also receive data from the CSC 640, once it has passed a verification 650, similar to block 630, to ensure it is in an acceptable format. For example, verification 650 may receive chroma data directly from the control block 520. Layer1_buf_mgr 660 may maintain a block level left column and top line buffer and combine input data with top and left buffer to form input data to directly feed core 540.

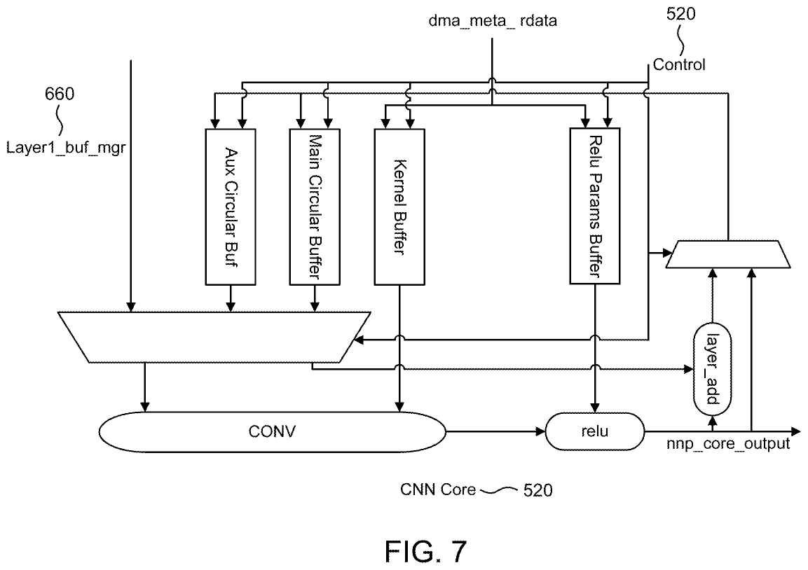

FIG. 7 illustrates an example architecture for the CNN Core 540. The core 540 may accept metadata from the DMA (e.g., dma_meta_rdata), and may write the data into a kernel and ReLU buffer, e.g., for CNN operations. Internal, in-place circular buffers and meta buffers may be applied and controlled by Control module 520. Such buffers may include an aux circular buffer, a main circular buffer, a kernel buffer, and ReLU parameter buffer.

Control information may be used to select data from at least one of a layer1_input, or one or two internal circular buffers, such as the aux buffer and/or main circular buffer. The selected control data may then be fed into the convolution circuit (CONV) and layer adder.

The convolution circuit may receive input data from a multiplexer/mux unit, for example, and may receive kernel parameters from a kernel buffer. Convolution results may then be fed into the ReLU circuit. ReLU parameters may also be fed into the ReLU circuit. The ReLU circuit, along with any special functions (e.g., from ReLU params buffer), may produce a layer result. The layer result may be fed back to the in-place circular buffer, e.g., for the next layer (see, e.g., layer_add), or sent to the Post-Process block 530 if the layer result is the final layer.

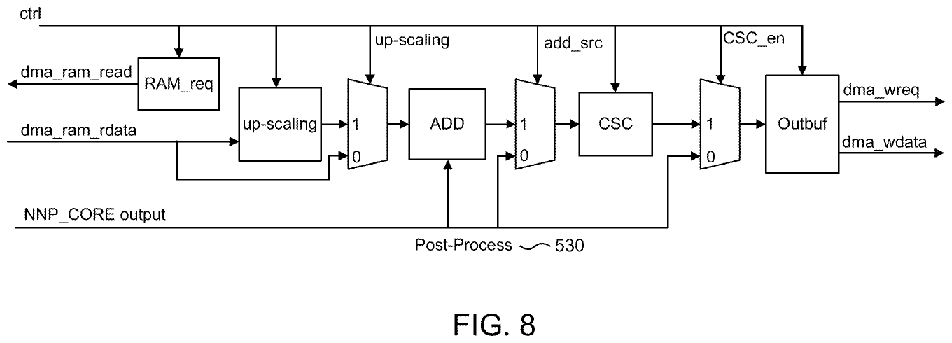

FIG. 8 illustrates the Post-Process architecture 530. A RAM_req module may request block level signals from Control 520 to generate dma_ram_read, which reads source RGB data as needed. As discussed above, at Pre-Process 510, image data may be up-scaled to RGB. DMA_ram rdata feeds into an up-scaling module, which generates up-scaling output in the raster order to match the core output.

The ADD block can add the core output with source RGB data from mux logic to pick up-scaling data or non-scaling data. The CDC may perform color space conversion from RGB444 to chroma444, then from chroma444 to chronma420. The CSC input from the mux logic may directly provide the output from the Core output and/or the result from the ADD circuit. Accordingly, outbuf provides global output parameters from control 520, and receives output data from the CSC and/or the core 540 to form output packets to DMA.

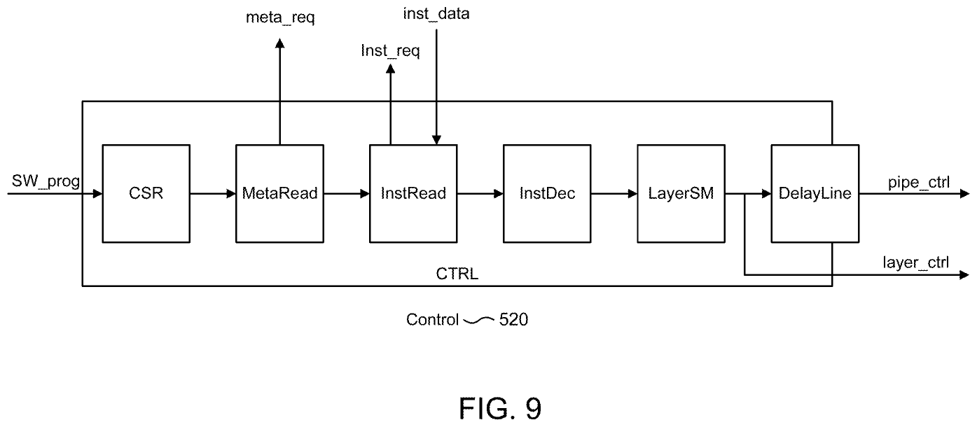

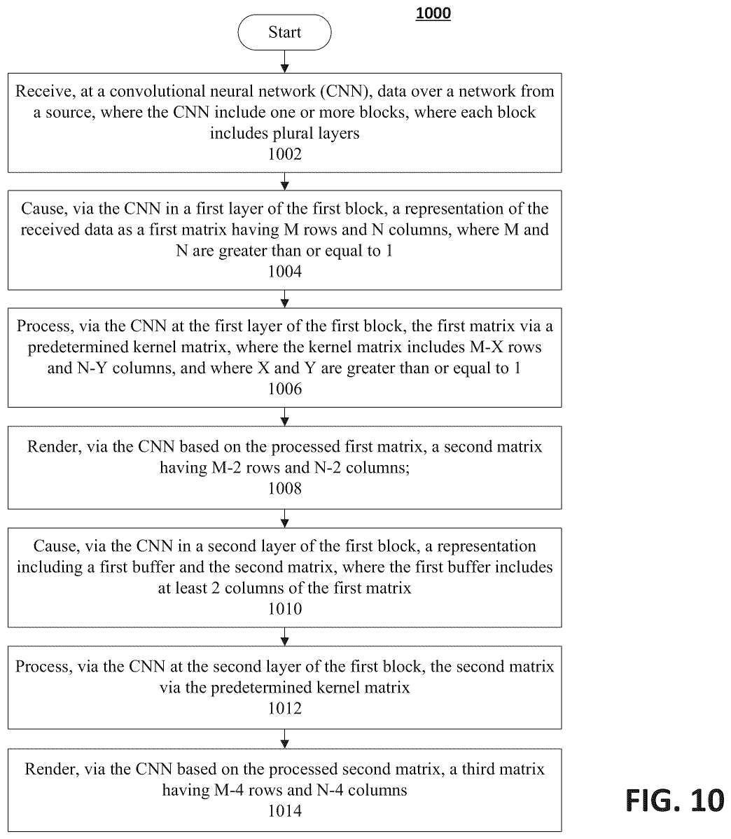

FIG. 9 illustrates an example architecture of Control 520. As discussed herein, the control block 520 enables seamless communication and integration between the Pre-Process, Post-Process, and Core blocks. At the Control block, a software program's global parameters passes through the CSR block and serves to prepare all other metadata in the memory. The MetaRead block responds to the CSR block to send metadata read requests, as needed. The metadata read return may go directly to metadata buffer of Core 540.

Once the MetaRead setup cycle is complete, InstRead module may request and receive instructions. For example, InstRead may send instruction read requests to stream in block-based through the DMA. In some examples, such read requests occur if InstRead has the buffer to receive additional instructions. As long as instructions are available, the InstDec block may decode the instructions for hardware execution.

When decoded instructions are available for a block layer to run, LayerSM will start and send the layer level and pipeline level control signals to coordinate other Core systems to run.

The DelayLine block may provide a phase alignment process. For example, once pipeline level control signals are generated, such control signals pass through the DelayLine block to perform phase alignment. Aligned pipeline control signals may then be sent to other blocks and modules to complete CNN operations at the different pipeline stages.

### In-Place Circular Buffer

According to an aspect of the present application, the architecture may include an in-place circular buffer for CNNs. In one example, the architecture may reside at a server. Alternatively, the architecture may reside on a consumer product, such as for example AR/VR glasses. More specifically, the architecture may include a processor operably coupled to one or more databases that may include the CNN. In an example, the processor may be the processor(s) 120 in FIG. 1B. The CNN may be the CNN 150 as depicted in FIG. 1B. The CNN may include one or more blocks. The one or more blocks may include, for example, an information component 130, a training component 132, a prediction component 134, a trajectory component 136, and an annotation component 138.

According to an example, data may be located in an external memory, such as for example, a DDR memory. The data may include any one or more of image data or video data. In an example, the data may include pixels. In an example, the external memory may be depicted as external memory 190 in FIG. 1B. External memory 190 may communicate with the system including the processor(s) 120 and CNN 150 via network 170.

FIG. 10 is a flowchart of an example process 1000. In some implementations, one or more process blocks of FIG. 10 may be performed by a device.

As shown in FIG. 10, process 1000 may include receiving, at a convolutional neural network (CNN), data over a network from a source, where the CNN include one or more blocks, where each block includes plural layers, (block 1002). For example, the device may receive, at a convolutional neural network (CNN), data over a network from a source, where the CNN may include one or more blocks, where each block may include plural layers, as described above. As also shown in FIG. 10, process 1000 may include causing, via the CNN in a first layer of the first block, a representation of the received data as a first matrix having M rows and N columns, where M and N are greater than or equal to 1 (block 1004). For example, the device may cause, via the CNN in a first layer of the first block, a representation of the received data as a first matrix having m rows and n columns, where m and n are greater than or equal to 1, as described above. As further shown in FIG. 10, process 1000 may include processing, via the CNN at the first layer of the first block, the first matrix via a predetermined kernel matrix, where the kernel matrix includes M-X rows and N-Y columns, and where X and Y are greater than or equal to 1; rendering, via the CNN based on the processed first matrix, a second matrix having M-2 rows and N-2 columns; causing, via the CNN in a second layer of the first block, a representation including a first buffer and the second matrix, where the first buffer includes at least 2 columns of the first matrix; processing, via the CNN at the second layer of the first block, the second matrix (which overwrites the initial matrix) via the predetermined kernel matrix; and rendering, via the CNN based on the processed second matrix, a third matrix having M-4 rows and N-4 columns (block 406). For example, the device may process, via the CNN at the first layer of the first block, the first matrix via a predetermined kernel matrix, where the kernel matrix includes m-x rows and n-y columns, and where x and y are greater than or equal to 1; rendering, via the CNN based on the processed first matrix, a second matrix having m-2 rows and n-2 columns; causing, via the CNN in a second layer of the first block, a representation including a first buffer and the second matrix, where the first buffer includes at least 2 columns of the first matrix; processing, via the CNN at the second layer of the first block, the second matrix (which overwrites the initial matrix) via the predetermined kernel matrix; and rendering, via the CNN based on the processed second matrix, a third matrix having m-4 rows and n-4 columns, as described above.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

According to an example flowchart 1000 as shown in FIG. 10, the CNN may read the received data from the external memory 190 (Step 1002). The read data may be caused by the CNN to be represented as a first matrix in a first layer of a first block (Step 1004). For example, the first matrix may include M rows and N columns. M and N may be greater than or equal to 1. In an example, the matrix may be a square matrix.

Next, the first matrix may be processed at a first layer of the first block (Step 1006). Specifically, predetermined kernel matrix may be employed to shrink the size of the first matrix. The kernel matrix may have a size of M-X, N-Y in relation to the first matrix. X and Y may be greater than or equal to 1. In one example, the kernel may be a 3×3 matrix.

Subsequently, a second matrix may be rendered by the CNN based on the processed first matrix via the aforementioned kernel (Step 1008). The representation of the second matrix may be a size M-2, N-2 in relation to the first matrix. By processing the first matrix via the CNN, the data represented by the second matrix has a reduced size. According to an example, the representation of the second matrix may overwrite the representation of the first matrix.

According to step 1010 as depicted in FIG. 10, the CNN causes a representation in a second layer of the first block. This representation may include a first buffer and the second matrix. The first buffer may include at least 2 columns of the first matrix. In an example, these two columns of the first matrix may be located furthest to the right. Alternatively, these two columns of the first matrix may be those with the highest numerical number (e.g., columns 15 and 16 of columns 1-16).

According to step 1012 as depicted in FIG. 10, the second matrix may be processed by the predetermined kernel matrix. This may occur at the second layer of the first block. In so doing, the initial matrix may be overwritten.

According to step 1014 as depicted in FIG. 10, a rendering of a third matrix is produced. The rendering may be produced via the CNN based on the processed second matrix. The third matrix may have a size of M-4 and N-4. In an example, the representation of the third matrix may overwrite the representation of the second matrix.

According to a further example of this aspect, the rendering of the third matrix produced in step 1014 may be an output of the first block. In other words, the third matrix may be a final layer of the first block. As mentioned above, one or more blocks may exist in the CNN. The output of the first block may be transmitted to a source over the network. The source may be an external memory, such as for example, a DDR memory.

According to even a further example of this aspect, the CNN may receive and read additional data from the external memory. The additional data read by the CNN may be represented as a subsequent matrix in a first layer of a second block. The subsequent matrix may include M-T rows and N-U columns. T and U may be greater than or equal to 1. In an example, T may be equal to half of M. In one example, U may equal one half of N. For clarity, M and N are associated respective rows and columns of the initial matrix provided in the first layer of a first block.

In yet a further example of this aspect, the third matrix may not be a final matrix of the first block. In other words, there may be one or more layers in the block. In this instance, the CNN may cause in a third layer of the first block to represent at least (i) the representation of the third matrix; (ii) a second buffer; and (iii) the first buffer. More specifically, the second buffer may include at least 2 columns of the second matrix. In a preferred example, the second buffer may include 2 columns of the second matrix. The selected columns of the second matrix may be located furthest to the right. Alternatively, the selected columns may exhibit a highest numerical number (e.g., columns 9 and 10 from columns 1-10). The first buffer may include at least 2 columns of the first matrix. In a preferred example the first buffer may include two columns of the first matrix.

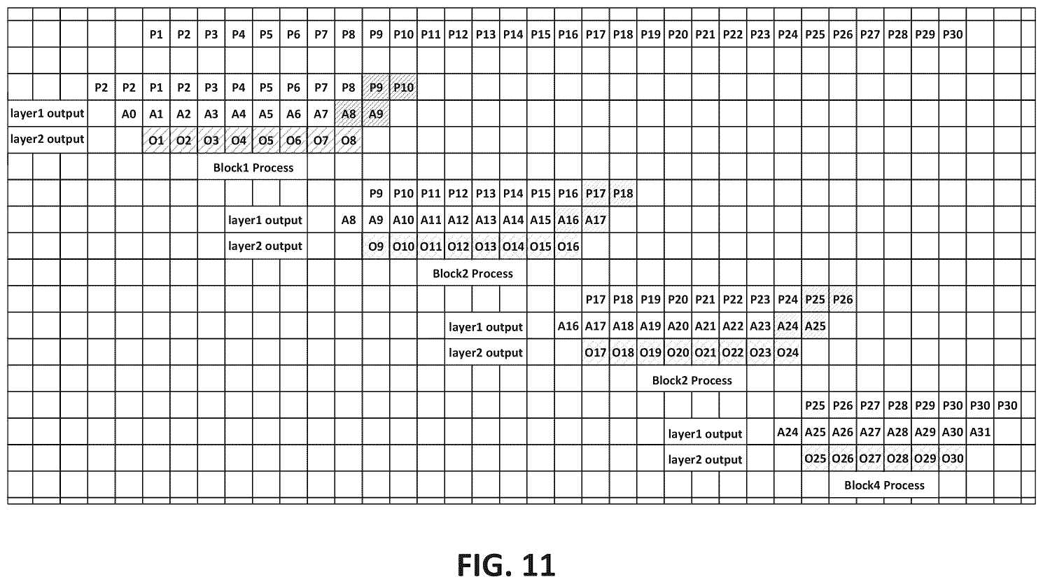

To further explain the concepts described above, the example depicted in FIG. 11 shows buffering of data at a layer which is included in a subsequent layer in a block. According to FIG. 11, four (4) blocks are presented. Each block goes through the CNN with 2 layers. To get the output for block 1, it has 10 inputs with the replications at the left boundary. After layer 1, A0 to A9 appear as a layer 1 output. This in turn is a layer 2 input. After the layer 2 process, the output is 01 to 08.

Next, Block 2 input is from P11 to P18. Layer 1 of Block 2 include 2 inputs P9 and P10 from Block 1. Block 2, layer 1 generates an output from A10 to A17 plus two inputs A8 and A9 saved from the Block 1 process. This forms the input for layer 2 of Block 2. After the layer 2 is processed, the CNN generates an output from 09 to 016.

The same process continues for Blocks 3 and 4. From the above process, each layer has 2 neighbor data to be saved for the next block process, the current layer result may be the input for the next layer. If each layer neighbor data is saved on one memory, the input data may use the other memory. According to an example, the operation may create corner cases, and the die size will be wasted since only layer 1 uses the max data size. Each of the subsequent layers may be shrunk. Hence, Layer 1 input may include 12 data and layer 2 may have 10 data at the beginning. Therefore, the in-place buffer may include 12 input data based upon 2 (layer 1 neighbor data)+2 (layer 2 neighbor data)+8 (working data buffer). All of the neighbor data may be embedded into the in-place buffer. A technical advantage of the application may be when more layers are involved. That is, a split buffer and input buffer requiring more memory to store neighbor data may be avoided by using the in-place circular buffer.

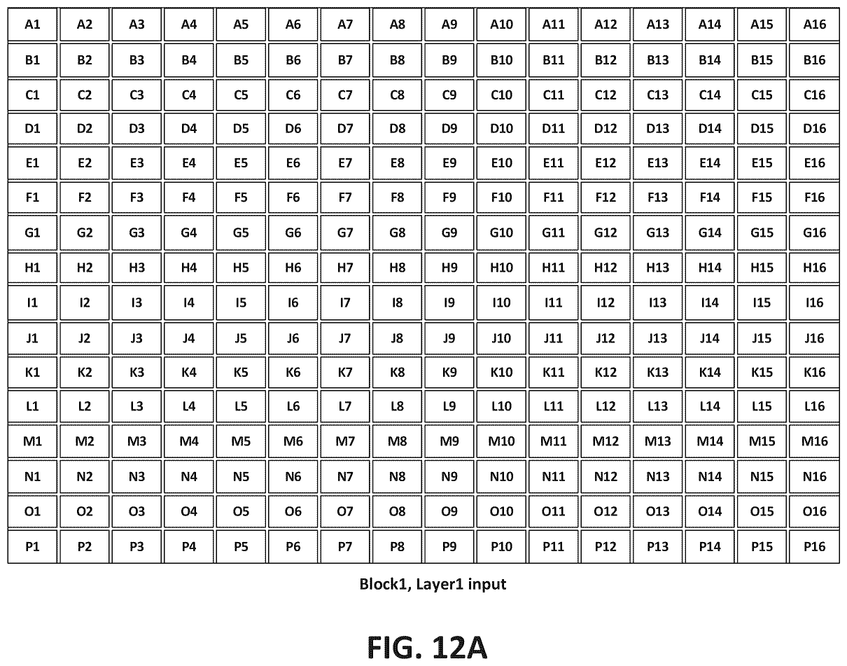

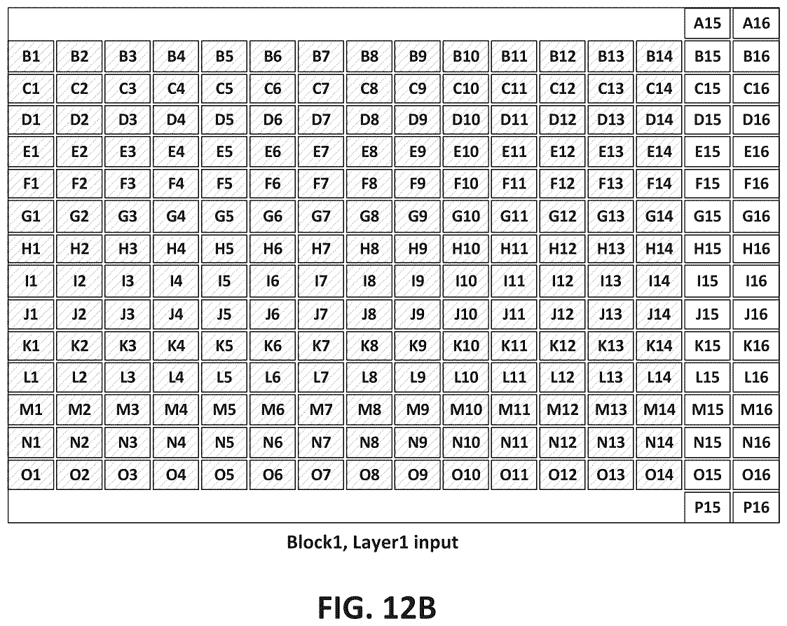

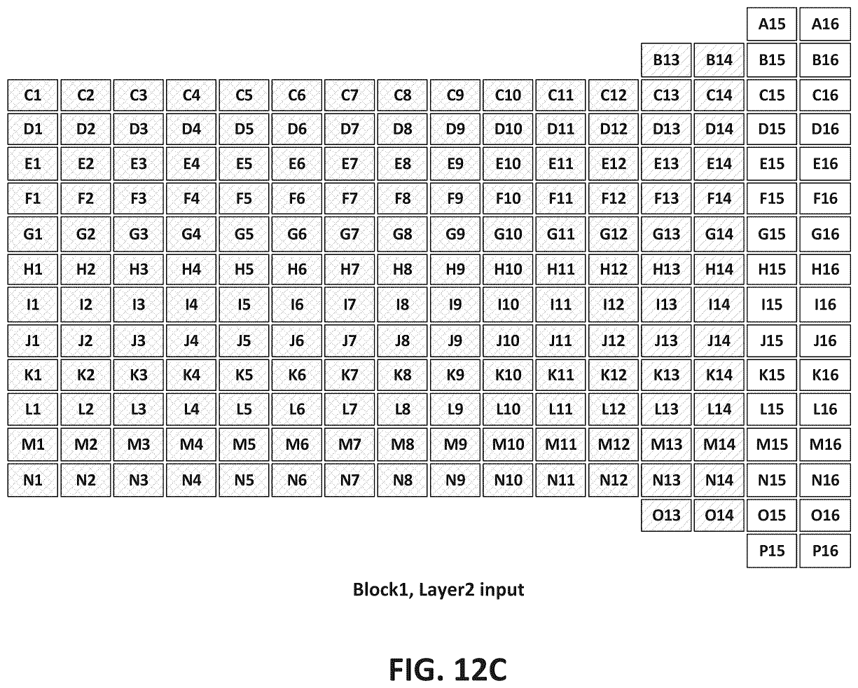

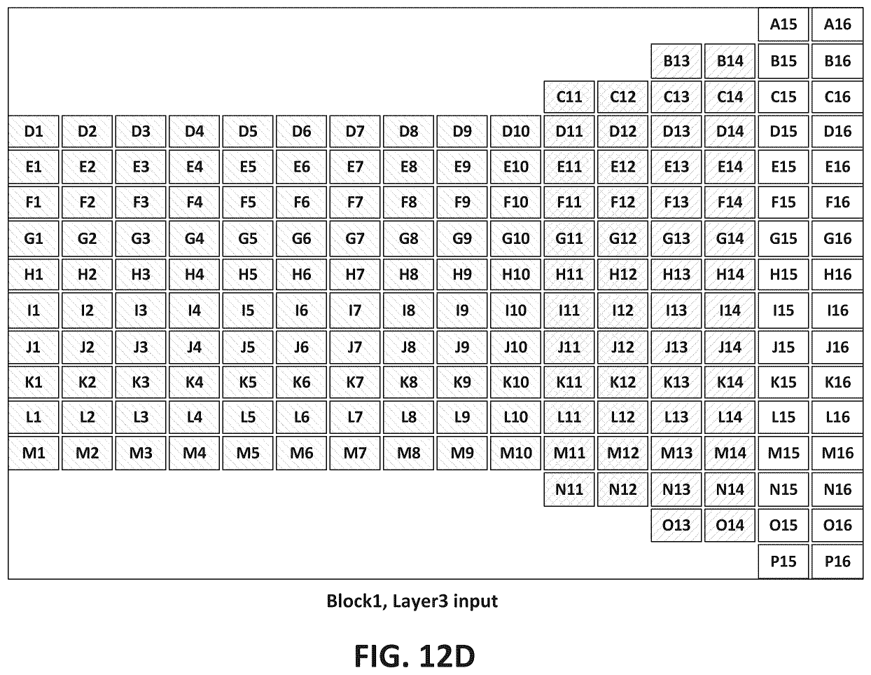

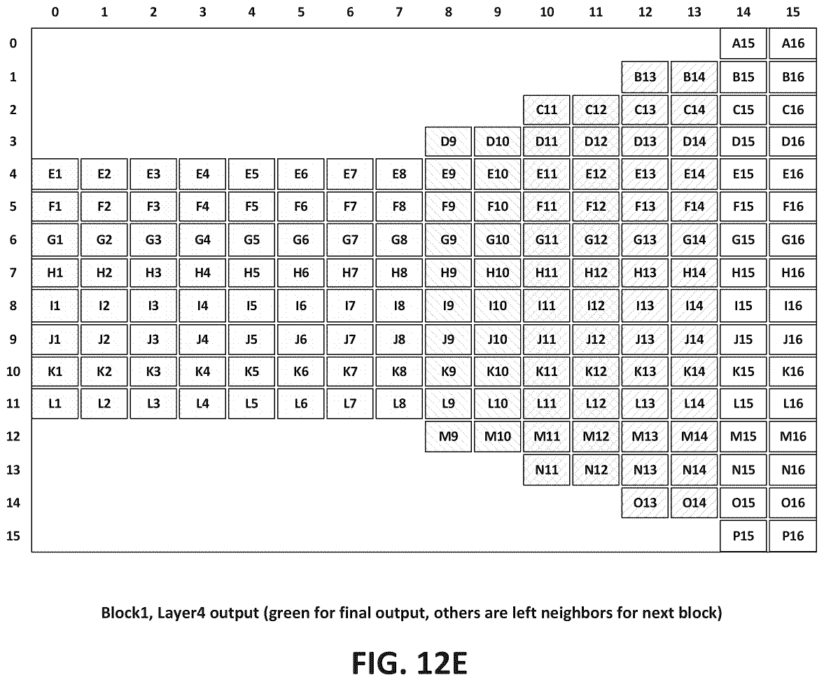

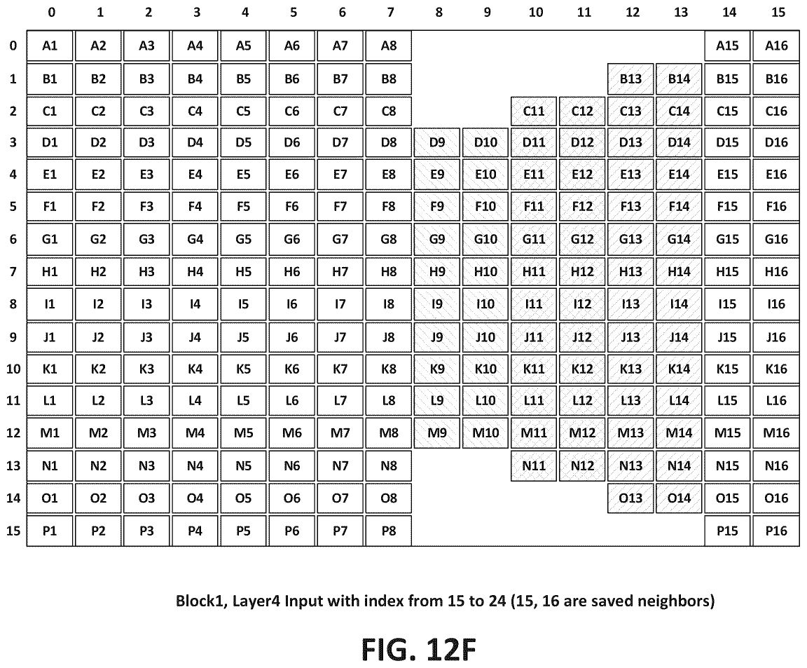

FIGS. 12A, 12B, 12C, 12D, 12E and 12F provide another example(s) employing the principles of the application. FIGS. 12A, 12B, 12C, 12D, 12E and 12F depict an in-place 2D buffer with an example size of 16×16. This is shown in FIG. 12A in which each block output is 8×8. In this example, the predetermined kernel is a 3×3 matrix with 4 layers. After the Block1 layer 1 process, columns 15 and 16 may be saved in-place in the buffer as the left neighbor for the next Block 2 layer 1 (FIG. 12B). Similar processes may be performed for layer 2 (FIG. 12C) and layer 3 (FIG. 12D) in Block 1. For instance, FIG. 12C is a representation including columns A15 and A16 buffered from layer 1's input, columns B13 and B14 buffered from layer 1 output, and columns C1-C12 of the layer 2 output. As observed, there are 2 fewer rows for columns B13 and B14 in comparison with columns A15 and A16. Similarly, there are 2 fewer rows for columns C1-C12 in comparison with columns B13 and B14. A similar methodology may be applied for FIG. 12D.

FIG. 12E may depict an output of Block 1. After all 4 layers are processed, the buffer includes 8 saved columns. The 8 saved columns are based upon 2 columns for each layer. These include columns A15 and A16 from layer 1, columns B13 and B14 from layer 2, columns C11 and C12 from layer 3, and columns D9 and D10 from layer 4.

FIG. 12F may depict additional data received from a source as index 17 to 24. The buffered data from block 1 are employed in Block 2, layer 1. In a circular buffer space, this buffer addressing is continuous and makes design easier. The neighbor data location for each layer and each block may be dynamically changing based on the usage model's kernel and the number of the layers.

B. Systems and methods for employing Instruction-Based Convolutional Neural Networks

### TECHNICAL FIELD

The present application generally is directed to systems and methods for employing instruction-based convolutional neural networks (CNNs).

### BACKGROUND

CNNs are being used to solve a vast array of challenging machine learning problems. These may include, for example, natural language processing, computer vision and recommendation systems. CNNs comprise a series of computation layers, where each layer takes the output of the preceding layer as its input. In so doing, CNNs may achieve extraordinary results with regard to image object recognition accuracy, object detection and classification. However, the trade-off for these results is high computational cost.

A CNN may include blocks with one or more layers. An in-place circular buffer may be employed in one or more of the blocks. While an in-place circular buffer may exhibit advantages in terms of die size, power and memory bandwidth saving, challenges still may exist with buffer management associated with CNN hardware circuit design. Particularly, when many layers exist for one or more blocks of a CNN coupled with plural buffers, data tracking among different applications may be extraordinarily difficult to manage. In turn, this may result in increased bugs requiring additional time and cost to validate.

What is desired in the art is a solution that decouples the complexity and intensive calculations required by existing CNN hardware circuit designs.

### BRIEF SUMMARY

One aspect of the application at least describes a method including a step of reading, via a convolutional neural network at a first layer of a block, an instruction associated with data of a size X, Y, where X and Y are greater than or equal to 1, and where the CNN includes one or more blocks with each block including plural layers. The process may also include a step of causing, via the CNN and a predetermined kernel matrix, a representation of the data as a first matrix in the first layer of the block, where the first matrix has a size X-M, Y-N, and where M and N are greater than or equal to 1. The process may further include a step of storing the representation of the data in a first circular buffer. The process may even further include a step of reading, at a second layer of the block, an instruction associated with the first matrix. The process may yet even further include a step of causing, via the CNN and the predetermined kernel matrix, a representation in the second layer including (i) a first repository associated with the first matrix and (ii) a second matrix of a size X-M-O, Y-N-P, where O is greater than or equal to 1 and P is greater than or equal to 2.

Another aspect of the application at least describes an apparatus including a non-transitory memory including stored instructions. The apparatus also includes a processor operably coupled to the non-transitory memory that is configured to execute the stored instructions. One of the instructions may include reading, via a convolutional neural network (CNN) at a first layer of a block, an instruction associated with data of a size X, Y, where X and Y are greater than or equal to 1, and where the CNN includes one or more blocks with each block including plural layers. Another one of the instructions may include causing, via the CNN and a predetermined kernel matrix, a representation of the data as a first matrix in the first layer of the block, where the first matrix has a size X-M, Y-N, and where M and N are greater than or equal to 1. Yet another instruction may include storing the representation of the data in a first circular buffer. Even another instruction may include reading, at a second layer of the block, an instruction associated with the first matrix. A further instruction may include causing, via the CNN and the predetermined kernel matrix, a representation in the second layer including (i) a first repository associated with the first matrix and (ii) a second matrix of a size X-M-O, Y-N-P, where O is greater than or equal to 1 and P is greater than or equal to 2.

It will be understood the methods and apparatuses described in the present application allow for an instruction-based solution that decouples the complexity and intensive calculations of conventional CNN hardware circuit designs. For example, one or more of the data buffers may be employed as a general-purpose register. The data buffer may provide firmware with full access to these general registers. An exemplary architecture according to the instant application describes an instruction-based approach such that firmware may require a small compiler to pre-generate instructions per application. In so doing, the instruction-based approach improves computer functionality by reducing hardware validation efforts based on solutions performed by firmware. In addition, the instruction-based approach may be seen as an improvement in the field of networking technology by preventing or reducing circuit data tracking issues.

### DESCRIPTION

### Instruction Format

According to an aspect of the present application, the CNN may include plural blocks each including one or more layers. Each of these layers in a block may include an instruction format. It is understood in this application that the instruction format may be customized and therefore different in another layer. One of the purposes of the instruction format is to assist with tracking data in the CNN. According to an example, these instructions are fashioned so as to have full capability to control one or more hardware internal buffers. These internal buffers may include a general-purpose 2D array in a circular fashion.

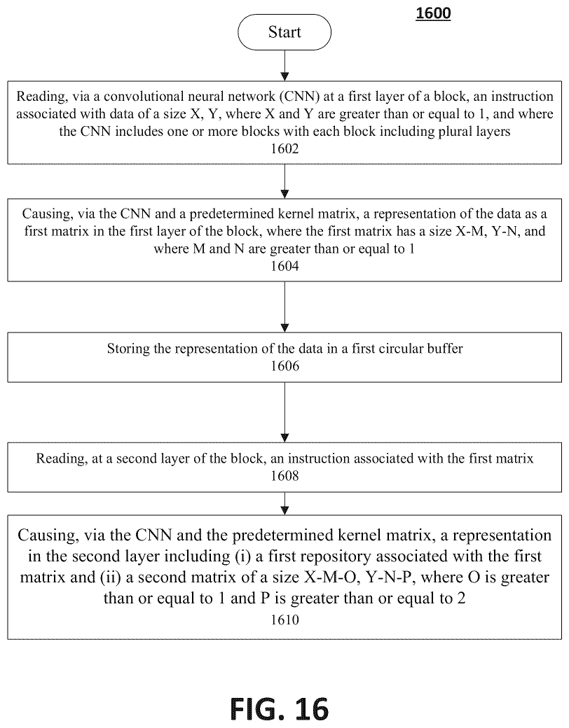

The instruction format is exemplarily illustrated in FIG. 16 according to an example of this aspect. As depicted the instruction format may include a head instruction, data read instruction, data right instruction, copy instruction, and fetch instruction. Each of these instructions may be discussed in turn below.

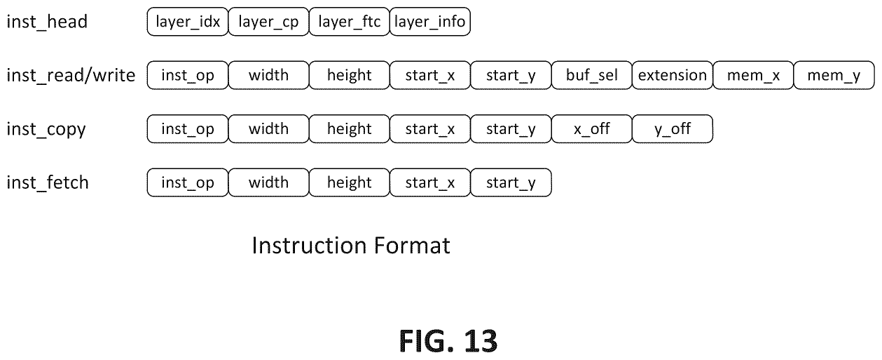

According to an example, FIG. 13 illustrates a first row of the instruction format being a head instruction. The head instruction includes a layer block header definition. The head instruction may include data associated with a “layer_idx,” “layer_cp,” “layer_ftc,” and “layer_info.” The “layer_idx” data indicates which layer is to be processed. For instance, the layer to be processed may be the first layer or may be one or more subsequent layers to the current block.

The “layer_cp” data may indicate whether the instant layer is to be saved for future use. The “layer_ftc” data indicates whether the instant layer may be added with a previously saved layer. The “layer_info” data stores other miscellaneous (misc.) layer information.

According to an example, FIG. 13 also illustrates a second row of the instruction format being a data read and/or write instruction. The data read/write instruction may include layer block data read location and size. The data/write instruction may include data associated with an “inst_op,” “width,” “height,” “start_x,” “start_y,” “buf_sel,” “extension,” “mem_x,” and “mem_y.”

The “inst_op” data may indicate one of the four instructions being read, write, copy and fetch. The “width” and “height” data may indicate a size of the block read/write/copy/fetch per instruction. The “buf_sel” data may indicate which buffer is selected for a read or write instruction.

The “start_x” and “start_y” data may indicate block start address in the circular buffer for each instruction. In an extension mode, start_x represents mem_x1 and mem_x0. The mem_x1 data may indicate high bits of external memory address. The mem_x0 data may indicate low bits of external memory address. According to an example, the “extension” may be only available for a first layer read instruction and a last layer write instruction to re-define an external memory address.

According to an example, FIG. 13 further illustrates the third row of the instruction format being a copy instruction. The copy instruction may indicate a layer block copy location and size. The copy instruction may include data associated with an “inst_op,” “width,” “height,” ‘start_x,’ ‘start_y,” “x_off,” and “y_off.” The descriptions provided above for the read/write instructions regarding “inst_op,” “width,” “height,” “start_x,” and “start_y” may be equally relevant for the copy instruction. The “x_off” and “y_off” data may indicate a start position of the result layer to be saved for future use.

According to yet another example, FIG. 13 illustrates the fourth layer of the instruction format being a fetch instruction. The descriptions provided above for the read/write and copy instructions regarding “inst_op,” “width,” “height,” “start_x,” and “start_y” may be equally relevant for the fetch instruction.

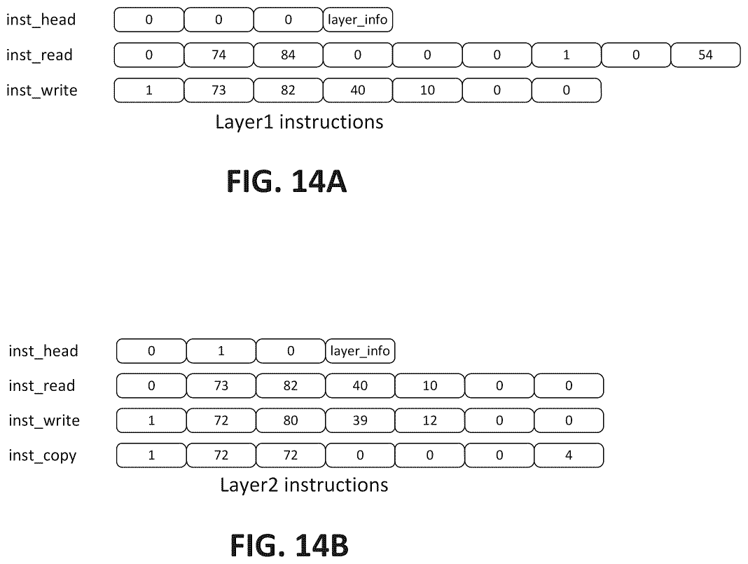

According to yet another example of this aspect, FIG. 14A and FIG. 14B illustrate instruction formats in each of layer1 and layer2, respectively. It is generally understood in this application that instructions may have variable lengths. That is, different instruction types may have different lengths. The same instruction type in a different layer defined in the inst_head may have the different length.

In an example case, it is presumed that an image size of 256×256 with multiple channels is received by the CNN from an external memory. The CNN model may have plural layers in a block. Each layer of the block may include one or more buffers. For example, two in-place buffers may be present at each layer. Each in-place buffer may have an image size of 92×92 with ‘n’ channels. In this example case, the block may include 10 layers. A 3×3 kernel may be exemplarily employed to process the received image.

As depicted in FIG. 14A, the layer 1 instructions includes a head instruction, read instruction and write instruction. There is no copy or fetch instruction in layer 1. The head instruction indicates zeros “Os” for each of “layer_idx,” “layer_cp” and “layer_ftc.”

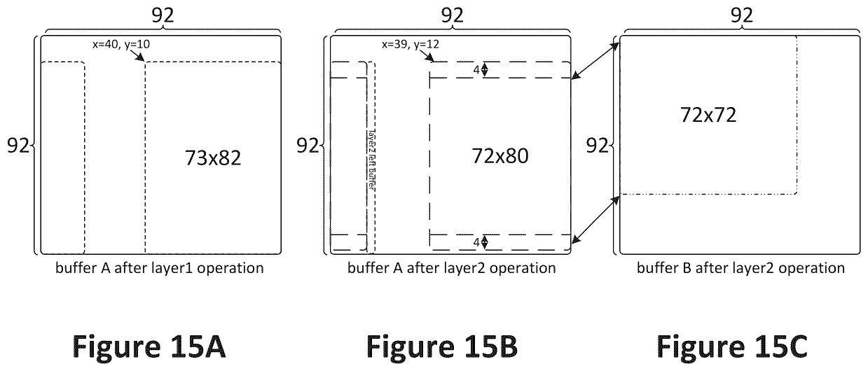

The read instruction in layer 1 indicates an image size having a width of 74 and a height of 84. The image size of layer 1 begins at an address of x=0, y=54. Based upon the predetermined 3×3 kernel and via the process of buffering, the image size is reduced as shown in the right instruction in layer 1. The write instruction in layer 1 indicates an image size having a width of 73 and a height of 82. The image size address begins at x=40, y=10. According to an example, FIG. 15A illustrates a first buffer with the changed data after the layer 1 operation according to instructions depicted in FIG. 14A. According to an example, there may be no buffer change for a second buffer in layer 1. This may be attributed to the copy instruction being zero in layer 1.

According to even a further example, FIG. 14B depicts layer 2 instructions including a head instruction, read instruction, write instruction and copy instruction. There may be no fetch instruction in layer 2. The head instruction indicates zeros “Os” for each of “layer_idx” and “layer_ftc” and a one “1” for the layer_cp. It is understood that a “1” for the layer_cp indicates a copy instruction and an image to be presented in a second buffer for layer 2.

As depicted in FIG. 14B, the read instruction of layer 2 may mirror the write instruction of layer 1. After being processed by the 3×3 kernel matrix, an output of the write instruction of layer 2 may have an image size including a width of 72 and a height of 80. The image size address begins at x=39, y=12. According to an example, FIG. 15B depicts the result after the layer 2 operation in a first buffer in layer 2. This may be represented by a long-hashed rectangular box on each of the left and right sides within the 92×92 buffer.

As generally understood in the context of this application, a portion of the image that has been buffered in FIG. 15A may be available in a first buffer of layer 2. This data may be represented by the short-hashed rectangular box in FIG. 15B with the text “layer2 left buffer” located therein. The short-hashed rectangular box contains 2 columns, and typically includes the last 2 columns of processed layer 1 (e.g., 2×82).

According to an example, layer 2 includes a copy instruction as depicted in FIG. 14B. It is envisaged according to the present application that the copy instruction may be included in any layer. That is, the copy instruction may be present at layer 2, layer 3, etc. up to the second to last layer in a block. The copy instruction indicates a portion of the data present in the first buffer after the layer 2 operation may be copied into a second buffer after the layer operation.

According to an example, the copy instruction may also include a value for y_off as depicted in FIG. 15B. It is envisaged according to the present application that the offset may be arbitrary. The y_offset indicates a value of ‘4’ in the layer 2 instruction of FIG. 14B. In so doing, the height of the 72×80 image present in FIG. 15B is reduced by the y_offset. This is represented by the reduction in 4 pixels from each of the top and bottom in FIG. 15B.

In view of the y_offset, the image size copied into the second buffer after the layer 2 operation is 72×72. This result is may be exemplarily depicted in FIG. 15C. The result depicted in FIG. 15C may be added to a subsequent layer in the block. For example, layer 6 may include a fetch instruction indicating the result stored in the second buffer after layer 2 may be added to layer 6.

It is envisaged that another technical accomplishment of this application is apparent over conventional architectures involving hardware designs. For example, hardware may require a simple instruction decoding circuit to decode the instructions of layer 1 and layer 2 depicted in FIGS. 14A and 14B, respectively. By contrast, the software described in this application may include a compiler to assist with a break down of a receive image into blocks and generate instructions for each layer in the block.

According to another aspect of the present application, a method of employing a CNN to add a copied result located in a buffer to a layer from a previous layer is provided. FIG. 16 exemplarily depicts an example of a process 1600.

According to an example of this aspect, the process may include a step of reading, via a convolutional neural network (CNN) at a first layer of a block, an instruction associated with data of a size X, Y, where X and Y are greater than or equal to 1, and where the CNN includes one or more blocks with each block including plural layers (Step 1602). The process may also include a step of causing, via the CNN and a predetermined kernel matrix, a representation of the data as a first matrix in the first layer of the block, where the first matrix has a size X-M, Y-N, and where M and N are greater than or equal to 1 (Step 1604). The process may further include a step of storing the representation of the data in a first circular buffer (Step 1606). The process may even further include a step of reading, at a second layer of the block, an instruction associated with the first matrix (Step 1608). The process may yet even further include a step of causing, via the CNN and the predetermined kernel matrix, a representation in the second layer including (i) a first repository associated with the first matrix and (ii) a second matrix of a size X-M-O, Y-N-P, where O is greater than or equal to 1 and P is greater than or equal to 2 (Step 1610).

According to a further example, the process 1600 may include a step of copying, to a second circular buffer in the block, a portion of the representation in the first or second layer or a subsequent layer, where the portion is smaller than the first or second matrix. The process 1600 may also include a step of retrieving the copied portion in the second circular buffer. The process 1600 may further include a step of adding the copied portion to a subsequent layer.

Some portions of this description describe the examples in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one example, a software module is implemented with a computer program product comprising a computer-readable medium containing computer program code, which can be executed by a computer processor for performing any or all of the steps, operations, or processes described.

Examples also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples also may relate to a product that is produced by a computing process described herein. Such a product may comprise information resulting from a computing process, where the information is stored on a non-transitory, tangible computer readable storage medium and may include any example of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
receiving, at a convolutional neural network (CNN), data over a network from a source, wherein the CNN includes one or more blocks, where each block includes plural layers;
causing, via the CNN in a first layer of the first block, a representation of the received data as a first matrix having M rows and N columns, where M and N are greater than or equal to 1;
processing, via the CNN at the first layer of the first block, the first matrix via a predetermined kernel matrix, wherein the kernel matrix includes M-X rows and N-Y columns, and where X and Y are greater than or equal to 1;
rendering, via the CNN based on the processed first matrix, a second matrix having M-2 rows and N-2 columns;
causing, via the CNN in a second layer of the first block, a representation including a first buffer and the second matrix, where the first buffer includes at least 2 columns of the first matrix;
processing, via the CNN at the second layer of the first block, the second matrix via the predetermined kernel matrix; and
rendering, via the CNN based on the processed second matrix, a third matrix having M-4 rows and N-4 columns.

2. The method of claim 1, further comprising:
causing, via the CNN in a third layer of the first block, a representation including a second buffer, the first buffer and the third matrix, where the second buffer includes at least 2 columns of the second matrix.

3. The method of claim 2, wherein the second buffer is located between the first buffer and the third matrix in the representation.

4. The method of claim 1, wherein the first buffer is located to the right of the second matrix in the representation.

5. The method of claim 1, wherein the representation in the second layer of the first block overwrites the representation in the first layer of the first block.

6. The method of claim 2, wherein the representation in the third layer of the first block overwrites the representation in the second layer of the first block.

7. The method of claim 1, further comprising:
transmitting, via the CNN after (i) the caused representation in the second layer of the first block or (ii) the rendered third matrix, an output of the first block to the source.

8. The method of claim 7, further comprising:
receiving, at the CNN, additional data; and
causing, via the CNN in a first layer of a second block, a representation of the additional data as a subsequent matrix having M-T rows and N-U columns, where T and U are greater than or equal to 1.

9. The method of claim 8, wherein T is half of M and U is half of N.

10. The method of claim 8, wherein the representation in the first layer of the second block includes the first buffer.

11. The method of claim 1, wherein the data includes an image and/or video.

12. The method of claim 1, wherein the matrix and/or predetermined kernel is a square matrix.

13. An apparatus comprising:
a non-transitory memory including stored instructions for; and
a processor operably coupled to the non-transitory memory and configured to execute the stored instructions including:
receiving, at a convolutional neural network (CNN), data over a network from a source, wherein the CNN includes one or more blocks, where each block includes plural layers;
causing, via the CNN in a first layer of the first block, a representation of the received data as a first matrix having M rows and N columns, where M and N are greater than or equal to 1;
processing, via the CNN at the first layer of the first block, the first matrix via a predetermined kernel matrix, wherein the kernel matrix includes M-X rows and N-Y columns, and where X and Y are greater than or equal to 1;
rendering, via the CNN based on the processed first matrix, a second matrix having M-2 rows and N-2 columns;
causing, via the CNN in a second layer of the first block, a representation including a first buffer and the second matrix, where the first buffer includes at least 2 columns of the first matrix;
processing, via the CNN at the second layer of the first block, the second matrix via the predetermined kernel matrix; and
rendering, via the CNN based on the processed second matrix, a third matrix having M-4 rows and N-4 columns.

14. The apparatus of claim 13, wherein the processor is further configured to execute the instructions of:
causing, via the CNN in a third layer of the first block, a representation including a second buffer, the first buffer and the third matrix, where the second buffer includes at least 2 columns of the second matrix.

15. The apparatus of claim 14, wherein the second buffer is located between the first buffer and the third matrix in the representation.

16. The apparatus of claim 13, wherein the first buffer is located to the right of the second matrix in the representation.

17. The apparatus of claim 13, wherein the representation in the second layer of the first block overwrites the representation in the first layer of the first block.

18. The apparatus of claim 14, wherein the representation in the third layer of the first block overwrites the representation in the second layer of the first block.

19. The apparatus of claim 13, wherein the processor is further configured to execute the instructions of:
transmitting, via the CNN after (i) the caused representation in the second layer of the first block or (ii) the rendered third matrix, an output of the first block to the source.

20. The apparatus of claim 13, wherein the processor is further configured to execute the instructions of:
receiving, at the CNN, additional data; and
causing, via the CNN in a first layer of a second block, a representation of the additional data as a subsequent matrix having M-T rows and N-U columns, where T and U are greater than or equal to 1.
